(19) United States
(12) Patent Application Publication
(10) Pub. No.: US 2026/0085007 A1
(43) Pub. Date: Mar. 26, 2026

(54) USE OF RECYCLED SUPERABSORBENT POLYMERS (SAPS) TO CREATE MULTIFUNCTIONAL CONCRETE

(71) Applicant: TEXAS STATE UNIVERSITY, San Marcos, CA (US)

(72) Inventors: Jung Heum Yeon, La Crescenta, CA (US); Rajesh Chakraborty, Chattogram (BD)

(73) Assignee: TEXAS STATE UNIVERSITY, San Marcos, CA (US)

(21) Appl. No.: 19/294,100

(22) Filed: Aug. 7, 2025

Related U.S. Application Data
(60) Provisional application No. 63/697,895, filed on Sep. 23, 2024.

(51) Int. Cl. C04B 24/24; C04B 20/02; C04B 28/04; C04B 103/00; C04B 111/34

(52) U.S. Cl. CPC C04B 24/24; C04B 20/023; C04B 28/04; C04B 2103/0051; C04B 2111/346; C04B 2201/50

(57) ABSTRACT

A method for forming concrete is disclosed. The method includes mixing recycled superabsorbent polymers (SAPs) with cement and aggregates. A method of forming recycled SAPs is also disclosed. The method includes neutralizing a mixture of SAP articles and a gel, purifying the mixture, and sieving the mixture into a powder. A concrete is also disclosed. The concrete includes recycled SAPs and cement. The concrete is formed by the methods of the present disclosure.

### CROSS-REFERENCE TO RELATED APPLICATIONS

This patent application claims priority from, and incorporates by reference the entire disclosure of, U.S. Provisional Patent Application 63/697,895 filed on Sep. 23, 2024.

### TECHNICAL FIELD

The present disclosure relates generally to concrete and more particularly, but not by way of limitation, to the use of recycled superabsorbent polymers (SAPs) to create multifunctional concrete.

### BACKGROUND

This section provides background information to facilitate a better understanding of the various aspects of the disclosure. The statements in this section of this document are to be read in this light, and not as admissions of prior art.

Portland cement concrete is one of the most widely used construction materials. Superabsorbent polymers (SAPs) are lightly crosslinked polymeric materials capable of quickly absorbing a substantial amount of water or aqueous solutions by osmotic pressure (˜500 times its mass) and are among the internal curing agents used in cementitious materials, and specifically portland cement concrete. Due to the superabsorbent nature of SAPs, they can improve the multifunctionality of the concrete by reducing shrinkage, improving mechanical properties such as strength and durability, controlling workability, sealing cracks, and improving freeze-thaw resistance. However, current SAPs have numerous limitations in terms of sustainability and economic feasibility.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In an embodiment, the present disclosure pertains to a method of forming concrete. In some embodiments, the method includes mixing recycled superabsorbent polymers (SAPs) with cement and aggregates. In some embodiments, the recycled SAPs are formed via a method that includes neutralizing a mixture comprising SAP articles and a gel, purifying the mixture, and sieving the mixture into a powder.

In another embodiment, the present disclosure pertains to a concrete having recycled superabsorbent polymers (SAPs) and cement. In some embodiments, the concrete is formed by the methods of the present disclosure.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1A illustrates an example of a recycled superabsorbent polymer (SAP) before and after water absorption.

FIG. 1B illustrates internal curing using recycled SAPs.

FIG. 1C illustrates an example method of forming concrete.

FIG. 1D illustrates an example method of forming recycled SAPs, such as through the method illustrated in FIG. 1C.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

The use of a highly absorptive material (i.e., superabsorbent polymers [SAPs]) can be used to improve the material properties and serviceability of portland cement concrete, one of the most widely used construction and building materials worldwide. However, current SAPs have numerous limitations in terms of sustainability and economic feasibility. As a result, the present disclosure seeks to leverage SAPs from recycled materials in concrete to mitigate these limitations.

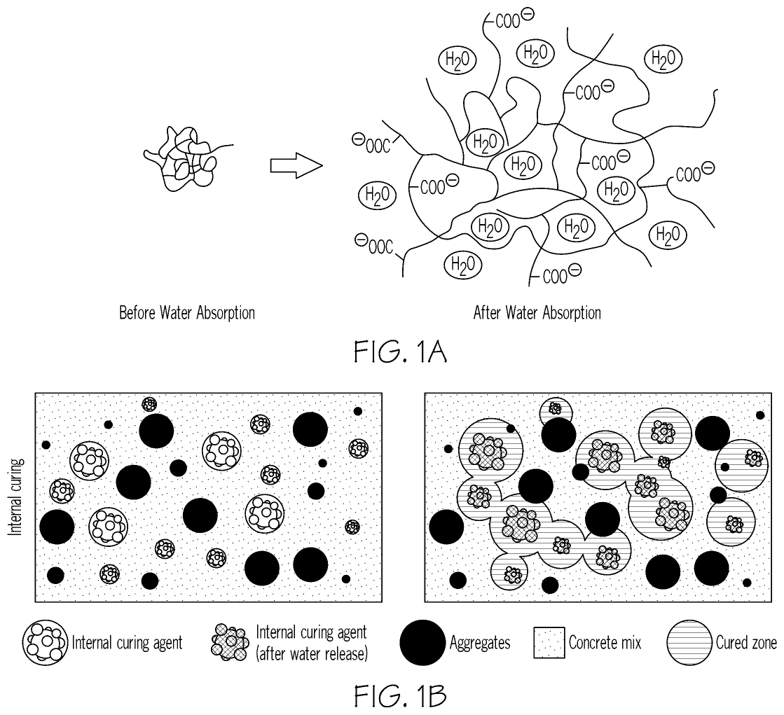

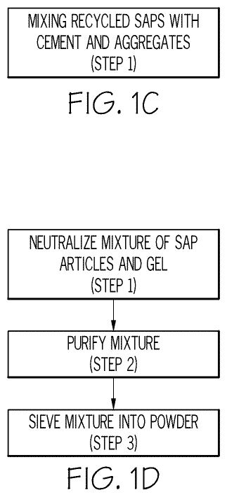

As illustrated in FIG. 1A, SAPs are lightly cross-linked polymeric materials capable of quickly absorbing a substantial amount of water or aqueous solutions by osmotic pressure (˜500 times their own mass). Taking advantage of such super-absorptive characteristics, SAPs can benefit various aspects of concrete, such as shrinkage cracking mitigation, mechanical properties improvement, rheological properties modification, self-sealing/self-healing, thermal cracking control, and freeze-thaw resistance enhancement. Compared to other existing technologies used for concrete curing, such as curing membrane application and internal curing by lightweight aggregates, the present disclosure offers improved effectiveness and practicality.

A distinguishable aspect of the present disclosure is the use of “recycled” SAPs instead of “virgin” SAPs (i.e., non-recycled SAPs). Recycled SAPs can be readily obtained from ice packs for food packaging/preservation, with massive amounts ending up in landfills, especially after the recent pandemic, which caused a surging demand for food delivery and food packaging. Given the novelty, aspects of the present disclosure are expected to improve economic and sustainability benefits significantly over the use of non-recycled SAPs.

Two common problems in concrete construction are plastic and dry shrinkage cracking. Plastic shrinkage cracks occur when the evaporation of moisture at the surface of the concrete is greater than the availability of rising bleed water to replenish the surface moisture. Aspects of the present disclosure have evaluated the influence of wider SAP dosages under different exposure environments on the microstructural densification of cementitious materials, and the development of strength and durability based on this. With SAP incorporation, hydrate crystallization most easily occurs in wet/dry conditions through hydration with externally supplied water and by internal SAP curing, which leads to the formation of the densest microstructures.

Microstructure densification further progresses as the SAP dosages increase. Despite the internal curing effect of SAPs, the compressive strength of 0.5% SAP specimens compared with those of the reference specimens decrease due to the SAP void's presence. However, these mechanical properties of the specimens are all recovered at later stages when exposed to the wet/dry conditions, forming the densest microstructures. As the SAP dosages increase, the sealing effect of SAPs improves the water permeability characteristics at early ages. The lowest water permeability coefficient is observed in the specimen exposed to wet/dry conditions, as the further hydration effect of SAPs is exerted with aging. Consequently, utilizing the appropriate number of SAPs and environmental conditions can effectively densify the internal pore structures, thereby securing concrete structures'mechanical and durable properties.

Additionally, the recycled SAPs of the present disclosure allow for curing without the need for an active, external curing process. In some embodiments, the recycled SAPs of the present disclosure cause internal curing of the concrete by releasing water. FIG. 1B illustrates the internal curing of SAPs in concrete.

As such, in some embodiments illustrated in FIG. 1C, the present disclosure pertains to a method of forming concrete. In some embodiments, the method includes mixing recycled SAPs with cement and aggregates (Step 1). In certain embodiments, the recycled SAPs are derived from, for example, landfills, waste materials, ice packs, food-related ice packs, diapers, or combinations of the same and like.

The recycled SAPS of the present disclosure can have numerous advantageous properties. For instance, in some embodiments, the recycled SAPs of the present disclosure reduce drying shrinkage of the concrete and induce a sealing effect by reabsorbing moisture when cracks occur, thereby enhancing compressive strength and durability of the concrete.

The recycled SAPs of the present disclosure may be present in concrete in various amounts. For instance, in some embodiments, the recycled SAPs of the present disclosure constitute at least about 0.1% by total weight of the concrete. In some embodiments, the recycled SAPs of the present disclosure constitute at least about 0.5% by total weight of the concrete. In some embodiments, the recycled SAPs of the present disclosure constitute at least about 1.0% by total weight of the concrete. In some embodiments, the recycled SAPs of the present disclosure constitute at least about 1.5% by total weight of the concrete. In some embodiments, the recycled SAPs of the present disclosure constitute at least about 2% by total weight of the concrete. In some embodiments, the recycled SAPs of the present disclosure constitute from about 0.1% to about 2% by total weight of the concrete.

In some embodiments, the recycled SAPs of the present disclosure include hydrophilic functional groups on their surfaces. For instance, in some embodiments, the recycled SAPs of the present disclosure include multiple hydroxyl groups on their surfaces.

In some embodiments, the cement may include portland cement or other types of cementitious materials. In some embodiments, the aggregates may include sand, gravel, crushed stone, recycled concrete, or combinations of the same and like. In some embodiments, the aggregates may be fine (e.g., materials that pass through a 4.75 mm sieve) or coarse (e.g., materials retained on a 4.75 mm sieve).

In some embodiments, mixing the aggregates can occur in stages. For example, in some embodiments, coarse aggregates are added, and subsequently, fine aggregates are added. In some embodiments, aggregates can be added before, during, or after the recycled SAPs.

In some embodiments, the method includes a step of adding water to the recycled SAPs. In some embodiments, the adding occurs during, prior to, or after the mixing step. In some embodiments, the adding can occur one or more times at different times. In some embodiments, the mixing results in the curing of the cement.

In certain embodiments, the methods of the present disclosure do not include an active external curing step/process. In some embodiments, the recycled SAPs cause internal curing of the cement. In some embodiments, the recycled SAPs cure the cement by releasing water.

In some embodiments, the formed concrete of the present disclosure includes multi-functional concrete. In some embodiments, the multifunctional concretes of the present disclosure improve compressive strength of the concrete by at least 4.2%. In some embodiments, the multifunctional concretes of the present disclosure improve a concrete's crack sealing effect by at least 8.2%.

In some aspects of the disclosure illustrated in FIG. 1D, the SAPs are formed via a method that includes neutralizing a mixture of SAP articles and a gel (Step 1), purifying the mixture (Step 2), and sieving the mixture into a powder (Step 3). In some embodiments, the mixture is neutralized to a pH between ˜7-8. In some embodiments, neutralization may be performed with a sodium solution (e.g., NaOH). In some embodiments, the purifying may be performed by washing the mixture with ˜80-95% ethanol.

In other embodiments, the present disclosure pertains to a concrete having recycled superabsorbent polymers (SAPs) and cement. In certain embodiments, the concrete was not cured with an active external curing process. Rather, in some embodiments, the concrete was cured via an internal curing process. For example, in some embodiments, internal curing process was induced via the recycled SAPs. In some embodiments, the internal curing process was induced via a release of water by the recycled SAPs. In certain embodiments, the concrete is formed by any of the methods of the present disclosure.

The methods and concretes of the present disclosure provide numerous applications, each offering advantages that address current limitations. In some embodiments, the present disclosure leverages recycled SAPs to create multifunctional concrete. To explore a more environmentally and cost-effective solution, the present disclosure illustrates a method of creating multifunctional concrete using recycled SAPs. Many current technologies require external curing compounds, which require external application, supervision, and careful application of the compound to be effective and useful. In some embodiments, the methods described in the present disclosure eliminate the need for curing, which saves time, money, and labor requirements. Potential applications include government and private agencies that manage and supervise various levels of construction.

### ADDITIONAL EMBODIMENTS

Reference will now be made to more specific embodiments of the present disclosure and experimental results that provide support for such embodiments. However, the disclosure below is for illustrative purposes only and is not intended to limit the scope of the claimed subject matter in any way.

### Example 1

### Synthesis and Use of Recycled SAPs in Concrete

Recycled superabsorbent polymers (SAPs), typically recovered from absorbent hygiene products (AHPs) such as diapers and incontinence pads, exhibit distinct structural differences compared to virgin SAPs due to aging, exposure to contaminants, and chemical degradation during their lifecycle. Virgin SAPs, commonly composed of crosslinked sodium polyacrylate, are engineered for maximum absorbency and structural integrity. In contrast, recycled SAPs often exhibit reduced absorbency, altered surface morphology, and chemical degradation due to exposure to urine, feces, and cleaning agents during use and recycling.

Studies show that post-consumer SAPs undergo partial hydrolysis, altering the polymer's ion-exchange capacity and swelling behavior. Fourier-transform infrared spectroscopy (FTIR) analyses indicate increased intensity of OH stretching bands at 3600-3200 cm⁻¹ in recycled SAPs, attributed to moisture-exposed hydroxyl groups, and higher peak intensities at 2925 and 2854 cm⁻¹, indicating increased aliphatic CH₂ groups. These changes suggest exposure to CaCl₂ salt and other oxidants causes partial degradation and rearrangement of polymer chains [1,2].

Moreover, FTIR spectra of SAPs treated with sodium hypochlorite show negligible shifts in absorption bands, indicating minimal new chemical bond formation. However, increased band intensity suggests superficial oxidation [3]. This suggests that recycled SAPs retain their basic chemical functionality but have undergone surface modifications that affect their performance.

Additionally, compositional analyses post-use indicate a marked reduction in SAP content from 14-27% in fresh products to ˜5% in used AHPs, alongside contamination by cellulose, polyolefins, and biological waste [4-6]. These structural and compositional changes underscore the necessity to characterize and, if needed, reprocess recycled SAPs before being reused in construction materials.

As illustrated in FIG. 1A, SAPs are lightly cross-linked polymeric materials capable of quickly absorbing a substantial amount of water or aqueous solutions by osmotic pressure (˜500 times their own mass). Taking advantage of such super-absorptive characteristics, SAPs can benefit various aspects of concrete, such as shrinkage cracking mitigation, mechanical properties improvement, rheological properties modification, self-sealing/self-healing, thermal cracking control, and freeze-thaw resistance enhancement. Compared to other existing technologies used for concrete curing, such as curing membrane application and internal curing by lightweight aggregates, this Example offers improved effectiveness and practicality.

A distinguishable aspect of this Example is the use of “recycled” SAPs instead of “virgin” SAPs. Recycled SAPs can be readily obtained from ice packs for food packaging/preservation, with massive amounts ending up in landfills, especially after the recent pandemic, due to surging demand for food delivery and food packaging. Given the novelty, this Example is expected to improve economic and sustainability benefits significantly.

Two common problems in concrete construction are plastic and dry shrinkage cracking. Plastic shrinkage cracks occur when the evaporation of moisture at the surface of the concrete is greater than the availability of rising bleed water to replenish the surface moisture. This Example has evaluated the influence of wider SAP dosages under different exposure environments on the microstructural densification of cementitious materials and the development of strength and durability based on this. With SAP incorporation, hydrate crystallization most easily occurs in wet/dry conditions through hydration with externally supplied water and by internal SAP curing, which leads to the formation of the densest microstructures.

Microstructure densification further progresses as the SAP dosages increase. Despite the internal curing effect of SAPs, the ultrasonic pulse velocity and the compressive strength of specimens with 0.5% SAP compared with those of the reference specimens decrease due to the SAP void's presence. However, these mechanical properties of the specimens are all recovered at later stages when exposed to the wet/dry conditions, forming the densest microstructures. As the SAP dosages increase, the sealing effect of SAPs improves the water permeability characteristics at early ages. The lowest water permeability coefficient is observed in the specimen exposed to wet/dry conditions as the further hydration effect of SAPs is exerted with aging. Consequently, utilizing the appropriate number of SAPs and environmental conditions can effectively densify the internal pore structures, thereby securing concrete structures' mechanical and durable properties.

In sum, this Example recycles superabsorbent polymers (SAPs) to create multifunctional concrete. To explore a more environmentally and cost-effective solution, the Example pertains to a method of creating multifunctional concrete using recycled SAPs. Many current technologies require external curing compounds, which require external application, supervision, and careful application of the compound to be effective and useful. This Example eliminates the need for curing, which saves time, money, and labor requirements. Potential applications include government and private agencies that manage and supervise various levels of construction.

### Example 1.1

### Creation of Recycled Saps from Waste Materials

### Example 1.1.1

### Collection and Preparation

Collect used SAP articles (e.g., waste ice gel packs). Ensure they are free from contaminants. Cut open the packs and extract the gel content.

### Example 1.1.2

### Initial Cleaning

Place the gel content in a large container and rinse thoroughly with distilled water to remove any surface impurities. Filter the mixture using a filtration setup to separate the gel from any particulate matter. Discard the filtered water.

### Example 1.1.3

### Neutralization

Prepare sodium salts (i.e., a 1% NaOH solution). Slowly add the sodium salt solution to the gel while stirring continuously until the pH reaches 7-8. This neutralizes any residual acids in the gel.

### Example 1.1.4

### Purification

After neutralization, rinse the gel again with distilled water to remove any remaining NaOH. Filter the gel and allow it to drain completely.

### Example 1.1.5

### Alcohol Wash

To remove any organic impurities, wash the gel with 80-95% ethanol. Add enough ethanol to cover the gel and stir gently for 10 minutes. Filter and discard the ethanol. Centrifuge the gel to remove excess alcohol.

### Example 1.1.6

### Drying

Spread the gel evenly on a tray and place it in a drying oven set at 60° C. Dry the gel for 24 hours or until it achieves a constant weight.

### Example 1.1.7

### Sieving.

Once dried, sieve the gel into a fine powder. This powder constitutes the recycled SAP.

### Example 1.1.8

### Storage.

Store the recycled SAP powder in an airtight container to prevent moisture absorption.

### Example 1.2

### Applying the Recycled SAPs to Concrete Materials

### Example 1.2.1

### Determine SAP Absorption Capacity

Assess the SAP's absorption capacity under mixing conditions.

### Example 1.2.2

### Batch Ingredients

Measure and prepare all concrete ingredients (cement, sand, gravel, dry SAPs, and water) in buckets.

### Example 1.2.3

### Add Dry Aggregates and SAPs

Begin by adding coarse aggregate, followed by fine aggregate and dry SAPs, into the concrete mixer drum.

### Example 1.2.4

### Add Initial Water

Pour in half of the mixing water and rotate the mixture for one minute.

### Example 1.2.5

### Add Cement

Stop the mixer and add the batched cement.

### Example 1.2.6

### Add Remaining Water

Restart the mixer and gradually add half of the remaining water over thirty seconds while the mixer is rotating. Continue mixing for an additional three minutes.

### Example 1.2.7

### Rest Period

Halt the mixing process and allow the mixture to rest for two minutes.

### Example 1.2.8

### Final Mixing

Mix for an additional two minutes to achieve a consistent, well-blended concrete mixture.

### Example 1.3

### References

1. Takaya, C. A., Cooper, I., Berg, M., Carpenter, J., Muir, R., Brittle, S., & Sarker, D. K. (2019). Offensive waste valorisation in the UK: Assessment of the potentials for absorbent hygiene product (AHP) recycling. Waste Management, 88, 56-70.
2. Grabowska, B., & Holtzer, M. (2009). Structural examination of the cross-linking reaction mechanism of polyacrylate binding agents. Arch. Metall. Mater, 54(2), 427-437.
3. Deborde, M., & Von Gunten, U. R. S. (2008). Reactions of chlorine with inorganic and organic compounds during water treatment—kinetics and mechanisms: a critical review. Water research, 42(1-2), 13-51.
4. Deloitte, U. K. (2011). Absorbent hygiene products comparative life cycle assessment. Knowaste Bromsgrove, UK Available from https://diaperrecyclingeurope.eu/wp-content/uploads/2020/06/Diaper-Recycling-Europe-LCA-study-Knowaste-2011. pdf [last accessed 7 Sep. 2021].
5. Das, D. (2014). Composite nonwovens in absorbent hygiene products. In Composite Non-Woven Materials (pp. 74-88). Woodhead Publishing.
6. Kim, K. S., & Cho, H. S. (2017). Pilot trial on separation conditions for diaper recycling. Waste management, 67, 11-19.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those of ordinary skill in the art may better understand the aspects of the disclosure. Those of ordinary skill in the art should appreciate that they may readily use the disclosure as a basis for designing or modifying other processes and structures for carrying out the same purposes and/or achieving the same advantages of the embodiments introduced herein. Those of ordinary skill in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim is an open group. The terms “a”, “an”, and other singular terms are intended to include the plural forms thereof unless specifically excluded.

Conditional language used herein, such as, among others, “can”, “might”, “may”, “e.g. ”, and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments.

While the above detailed description has shown, described, and pointed out novel features as applied to various embodiments, it will be understood that various omissions, substitutions, and changes in the form and details of the embodiments illustrated can be made without departing from the spirit of the disclosure. As will be recognized, the various embodiments described herein can be embodied within a form that does not provide all the features and benefits set forth herein, as some features can be used or practiced separately from others. The scope of protection is defined by the appended claims rather than by the foregoing description. All changes that come within the meaning and range of equivalency of the claims are to be embraced within their scope.

What is claimed is:

1. A method of forming concrete, the method comprising:
mixing recycled superabsorbent polymers (SAPs) with cement and aggregates.

2. The method of claim 1, wherein the recycled SAPs are derived from at least one of landfills, waste materials, ice packs, food-related ice packs, diapers, or combinations thereof.

3. The method of claim 1, wherein the recycled SAPs comprise multiple hydroxyl groups on their surfaces.

4. The method of claim 1, wherein the cement comprises portland cement.

5. The method of claim 1, further comprising a step of adding water to the recycled SAPs.

6. The method of claim 5, wherein the adding occurs during, prior to, or after the mixing step.

7. The method of claim 1, wherein the mixing results in the curing of the cement.

8. The method of claim 1, wherein the method does not include an active external curing step.

9. The method of claim 1, wherein the recycled SAPs cause internal curing of the cement.

10. The method of claim 1, wherein the recycled SAPs cure the cement by releasing water.

11. The method of claim 1, wherein the formed concrete comprises multi-functional concrete.

12. The method of claim 1, wherein the recycled SAPs are formed via a method comprising:
neutralizing a mixture comprising SAP articles and a gel;
purifying the mixture; and
sieving the mixture into a powder.

13. The method of claim 1, wherein the recycled SAP constitutes from about 0.1% to about 2% by total weight of the concrete.

14. The method of claim 1, wherein the recycled SAP constitutes at least about 1% by total weight of the concrete.

15. A concrete comprising recycled superabsorbent polymers (SAPs) and cement.

16. The concrete of claim 15, wherein the recycled SAPs are derived from at least one of landfills, waste materials, ice packs, food-related ice packs, diapers, or combinations thereof.

17. The concrete of claim 15, wherein the recycled SAPs comprise multiple hydroxyl groups on their surfaces.

18. The concrete of claim 15, wherein the cement comprises portland cement.

19. The concrete of claim 15, wherein the concrete comprises multi-functional concrete.

20. The concrete of claim 15, wherein the concrete was not cured with an active external curing process.

21. The concrete of claim 15, wherein the concrete was cured via an internal curing process.

22. The concrete of claim 21, wherein the internal curing process was induced via the recycled SAPs.

23. The concrete of claim 21, wherein the internal curing process was induced via a releasing of water by the recycled SAPs.

24. The concrete of claim 15, wherein the concrete is formed by the method of claim 1.

25. The concrete of claim 15, wherein the recycled SAP constitutes from about 0.1% to about 2% by total weight of the concrete.

26. The concrete of claim 15, wherein the recycled SAP constitutes at least about 1% by total weight of the concrete.
